(19) United States
(12) Patent Application Publication
(10) Pub. No.: US 2024/0316601 A1
(43) Pub. Date: Sep. 26, 2024

(54) Frame And Handle For Pressure Washer

(71) Applicant: J. D. North America Corp., Waukesha, WI (US)

(72) Inventor: Paul Anthony Janik, Saukville, WI (US)

(21) Appl. No.: 18/609,696

(22) Filed: Mar. 19, 2024

Related U.S. Application Data
(60) Provisional application No. 63/453,334, filed on Mar. 20, 2023.

(51) Int. Cl. B08B 3/02; F16B 7/04; F16B 7/18

(52) U.S. Cl. CPC B08B 3/026; B08B 2203/0211; F16B 7/0413; F16B 7/182

(57) ABSTRACT

Systems and methods for a pressure washer or other system to transport and distribute liquid are provided with an improved frame and handle. The pressure washer system includes a frame, a container carried by the frame, a pump, a dispenser, and a handle connected to the frame. The handle is rotatable relative to the remainder of the pressure washer system from a use-based position in which the handle is upwardly oriented and can be pushed to move the pressure washer from one location to another, and a stowed position in which the handle is downwardly oriented such that the pressure washer system has reduced dimensions and can more easily be stored. For instance, an upper portion of the handle can be releasably secured to a lower portion of the handle associated with the frame. The upper portion of the handle can be rotated relative to the lower portion.

### CROSS-REFERENCE(S) TO RELATED APPLICATION(S)

This application claims the benefit of priority on U.S. Provisional Patent Application Ser. No. 63/453,334, filed on Mar. 20, 2023 and entitled Improved Frame and Handle for Pressure Washer, the entirety of which is hereby incorporated by reference.

### BACKGROUND OF THE INVENTION

### 1. Field of the Invention

The present invention relates in general to the field of pressure washers. More particularly, the present invention relates to a pressure washer having an adjustable handle that can quickly and easily be moved relative to the pressure washer and an associated frame. Specifically, a preferred embodiment of the present invention relates to a handle that can easily be rotated to a collapsed or stowed position which improves the storage capacities of the pressure washer. The present invention further includes a storage caddy that simplifies the storage of components associated with the pressure washer. The present invention also includes a front shroud that covers at least a portion of the pressure washer.

### 2. Discussion of the Related Art

Pressure washers are well known in the industry. Common pressure washers include a frame that carries the various components of the pressure washer to enable the pressure washer to be wheeled to a particular location, after which it can be used to spray water or other fluid or cleaner under high pressure to clean a surface, remove stains, and the like. These pressure washers typically have a rigid handle having a crossbar that is either permanently or semi-permanently installed relative to the frame. For instance, many typical pressure washers have an inverted U-shaped handle, akin to those commonly used with push lawnmowers, snowblowers/snow throwers, and the like. Such a handle allows a user to wheel the pressure washer to a desired location. Unfortunately, these types of handles make the pressure washer bulky, such that storage can be a challenge, particularly where the pressure washer is stored in a garage, shed, or the like where minimal space is available.

Additionally, many pressure washers have a variety of exposed components, for instance those associated with the engine, the pump, and other features of the washer. In many instances, access to these exposed components is not required for day-to-day use of the pressure washer, and these exposed components can be unsightly. Also, dust, debris, and other components can inadvertently get located between these components.

Further still, pressure washers come equipped with a variety of additional components for operation, including various hoses, sprayers, attachments, and the like. It can be challenging to keep track of all of these components, particularly those that are only needed when the pressure washer is used under specific modes of operation.

What is therefore needed is a pressure washer having an improved frame and handle that enables the handle to be moved or rotated into a collapsed or downward position to assist with storage of the pressure washer. What is further needed is a pressure washer having a shroud that can provide cover of exposed components of the pressure washer for improved visual appearance, and to help users identify the features of a given component that need to be manipulated during regular use of the pressure washer. What is further needed is a storage section or device associated with the pressure washer to enable a user to keep associated components close to the pressure washer.

### SUMMARY AND OBJECTS OF THE INVENTION

By way of summary, the present invention is directed to an improved pressure washer system that includes a frame, a container carried by the frame that is configured to receive a volume of liquid, a pump configured to pump the liquid from the container, a dispenser attached to the container for distributing the liquid out of the container, and a handle connect to the frame. The handle is configured to be movable or rotatable relative to the frame between a use-based position and a stowed position. When in the use-based position, the handle can be pushed in order to propel the pressure washer. When in the stowed position, the dimensions of the pressure washer are smaller than the dimensions of the pressure washer when the handle is in the use-based position, which helps for storage purposes.

According to another aspect of the present invention, the handle further comprises a lower handle section that fixedly extends from the frame, an upper rotating handle section that is rotatable relative to the lower handle section, and a gripping handle section that fixedly extends from the upper rotating handle section. The upper rotating handle section is releasably secured to the lower handle section. For instance, the upper rotating handle section may be releasably secured to the lower handle section by a quick clamp, it may be releasably secured to the lower handle section using a combination of a mounting shaft collar and a screw, or it may otherwise be releasably secured to the lower handle section using other releasably securable features or devices. The upper rotating handle section may rotate approximately 180 degrees relative to a longitudinal axis extending through the pressure washer when it is rotated relative to the lower handle section in order to move the handle from the use-based position to the stowed position. Furthermore, the upper rotating handle section can be substantially parallel to the ground when in the stowed position.

According to another aspect of the present invention, the pressure washer may include additional components or features. For instance, a storage caddy may be provided that is configured to receive and transport one or more of a hose, a wand, and an accessory. Additionally, a shroud may be provided, which can quickly and easily be mounted to a portion of the pressure washer to surround a portion of the pressure washer and create an aesthetically appealing appearance. The shroud may also include at least one opening formed therein that allows components associated with the pressure washer to extend through the shroud. For instance, the pressure washer may have an adjustable pressure knob that is located between the container and the dispenser, where the knob extends through an opening in the shroud. The adjustable pressure knob may be configured to be rotated 360 degrees or less. More specifically, the adjustable pressure knob may be adjustable between a first opened position and a second closed position. When in the first opened position, the adjustable knob is at a substantially 1 degree angle relative to the Y-axis in which the liquid is pumped from the container to the dispenser. When in the second closed position, the adjustable knob is at a substantially 359 degree angle relative to the Y-axis in which the liquid remains within the container.

According to another aspect of the present invention, a method of using a pressure washer system is provided. The method includes the steps of filling a container with a volume of liquid, moving the pressure washer system to a desired location by pushing a handle, controlling the flow of the liquid from the container, pumping at least some of the volume of liquid from the container, moving the pressure washer system to a storage area once use is complete, and moving the handle to a stowed position. The method may further include the steps of propelling the pressure washer system when the handle is in a use-based position where it extends rearwardly from the pressure washer system and rotating the handle to the stowed position in which the dimensions of the pressure washer system are smaller than the dimensions of the pressure washer system when the handle is in the use-based position. Further still, the method may include the steps of propelling the pressure washer system in a frontward direction when the handle is in the use-based position by pushing the handle from the rear of the pressure washer system toward the front of the pressure washer system, and propelling the pressure washer system in the frontward direction when the handle is in the stowed position by pulling the handle from the front of the pressure washer system toward the front of the pressure washer system.

According to another aspect of the present invention, the method may further include the steps of releasing an upper rotating handle section from releasable engagement with a lower handle section and rotating the upper rotating handle section relative to the lower handle section. Additionally, the method may include the step of disengaging a quick clamp configured to releasably hold the upper rotating handle section in place relative to the lower handle section, rotating the upper rotating handle section relative to the lower handle section, and reengaging the quick clamp to releasably hold the upper rotating handle section in place relative to the lower handle section. The method may also include the steps of rotating a screw in a first direction to loosen a collar configured to releasably hold the upper rotating handle section in place relative to the lower handle section, rotating the upper rotating handle section relative to the lower handle section, and rotating the screw in a second direction to tighten the collar to releasably hold the upper rotating handle section in place relative to the lower handle section. Further still, the method may include the step of rotating the upper rotating handle section approximately 180 degrees relative to a longitudinal axis extending through the pressure washer from the use-based position to the stowed position.

Additionally, the method may include the step of mounting a shroud to a front section of the pressure washer system to surround at least a portion of the front section. This can include inserting an adjustable pressure knob through an opening in the shroud when the shroud is mounted. The adjustable pressure knob may be moved between a first opened position and a second closed position. Further still, the adjustable pressure knob may have a plurality of intermediate positions between the first opened position and the second closed position.

According to another aspect of the present invention, a system configured to transport and distribute liquid is provided that includes a frame, a container carried by the frame, and a handle connected to the frame that is movable relative to the frame between a use-based position and a stowed position. The handle may be upwardly oriented and pushed to propel the pressure washer in the use-based position, and downwardly oriented and closer to the frame and container in the stowed position.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRA WINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

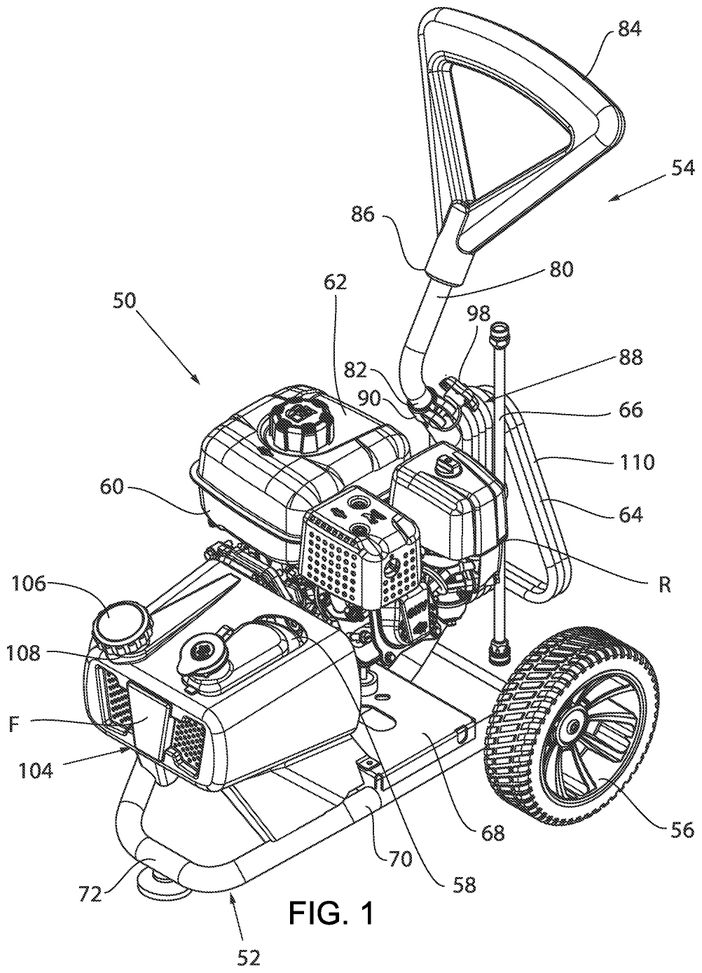

FIG. 1 is a top isometric view of an inventive pressure washer system having a handle in a first, use-based position;

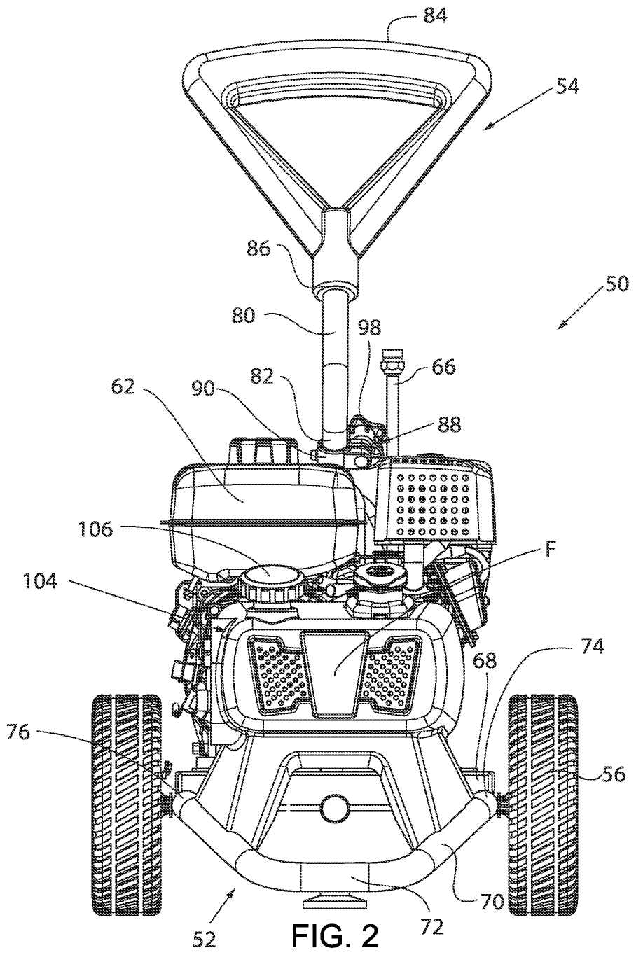

FIG. 2 is a front elevation view of the inventive pressure washer system of FIG. 1;

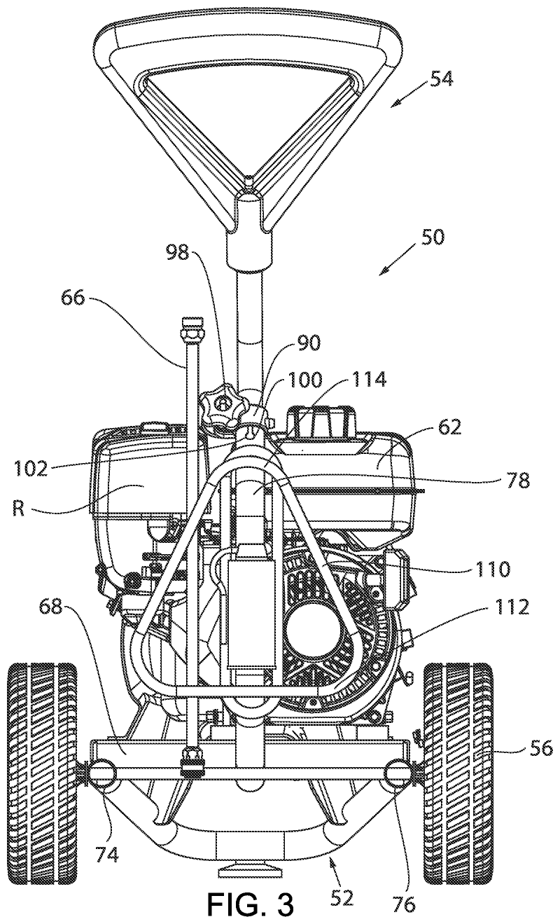

FIG. 3 is a rear elevation view of the inventive pressure washer system of FIGS. 1 and 2;

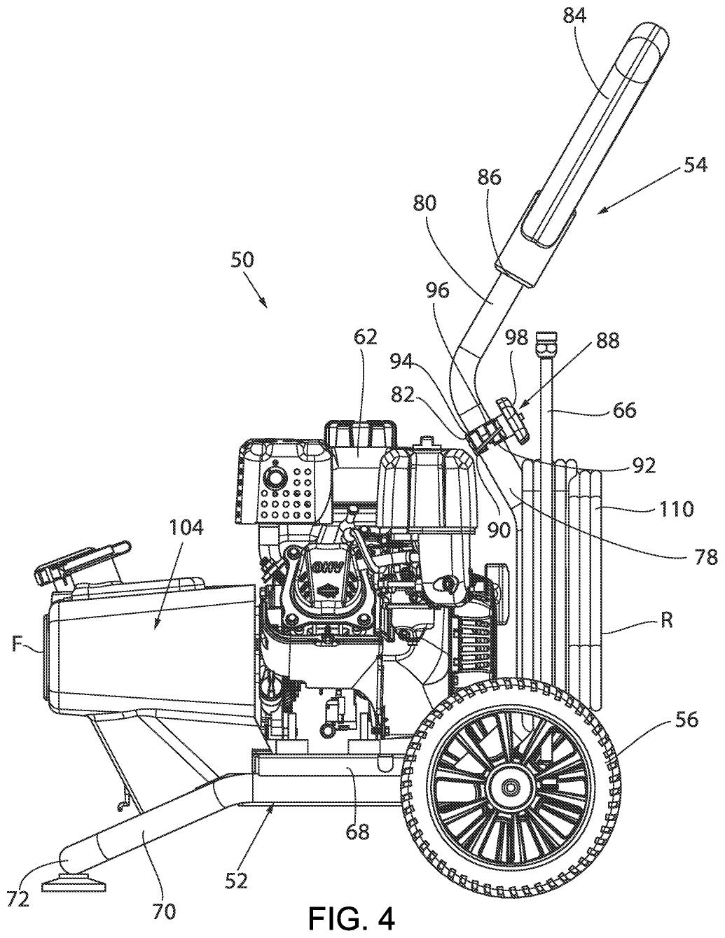

FIG. 4 is a first side elevation view of the inventive pressure washer system of FIGS. 1-3;

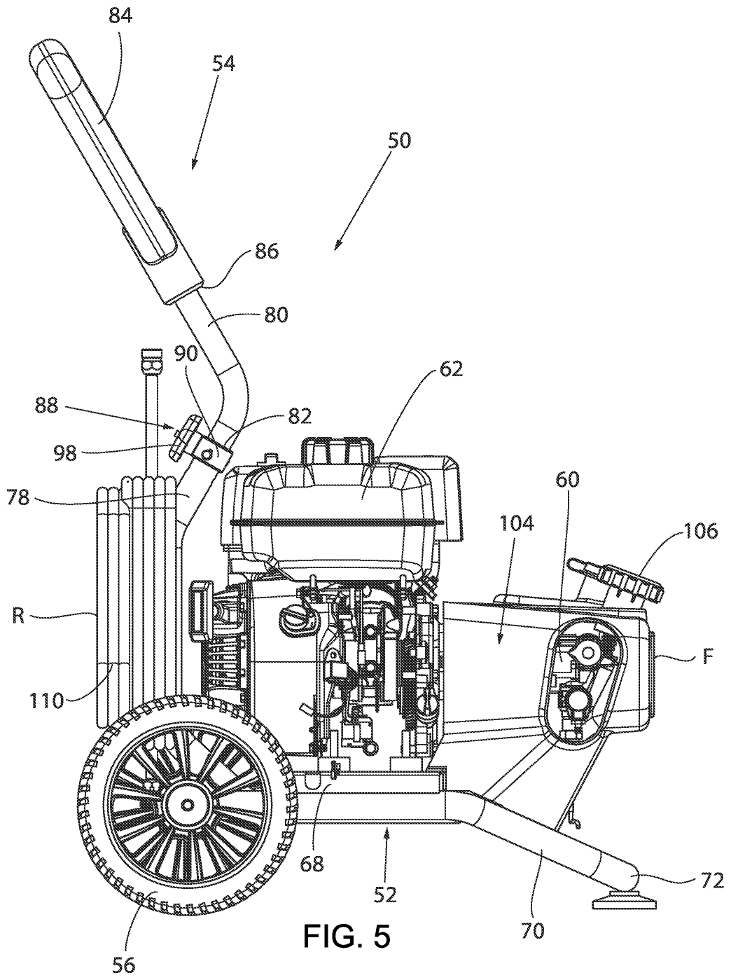

FIG. 5 is a second side elevation view of the inventive pressure washer system of FIGS. 1-4;

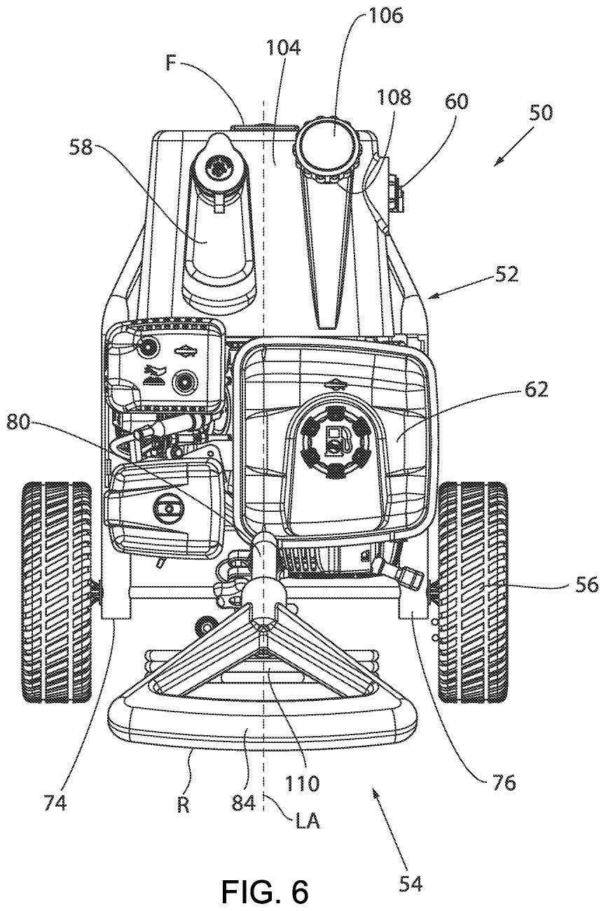

FIG. 6 is a top plan view of the inventive pressure washer system of FIGS. 1-5;

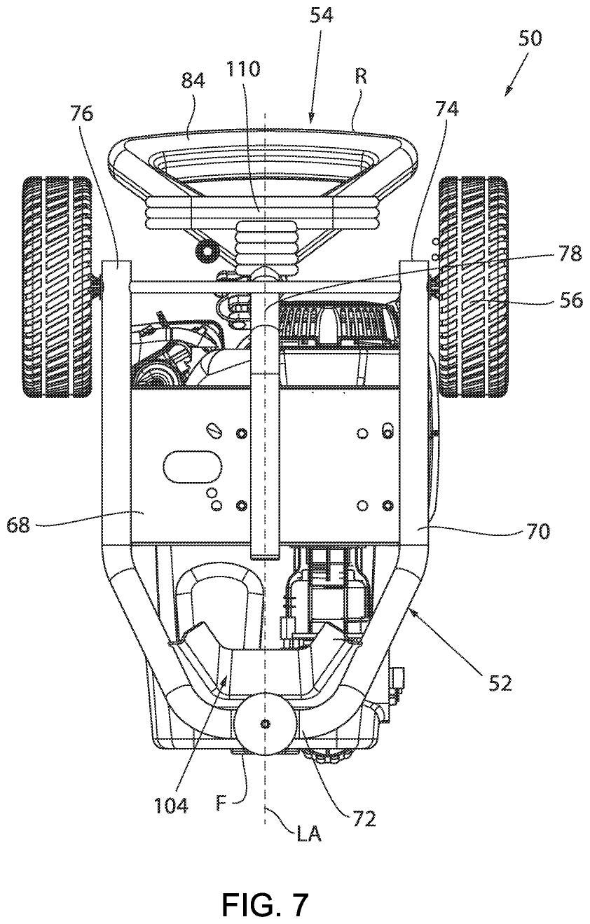

FIG. 7 is a bottom plan view of the inventive pressure washer system of FIGS. 1-6;

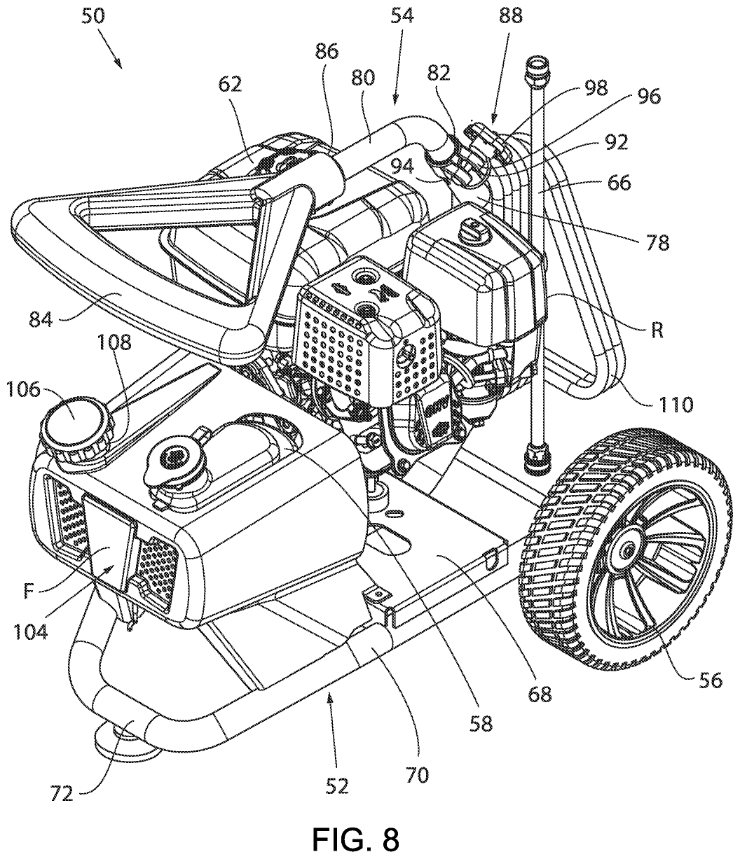

FIG. 8 is a top isometric view of an inventive pressure washer system having a handle in a second, use-based position;

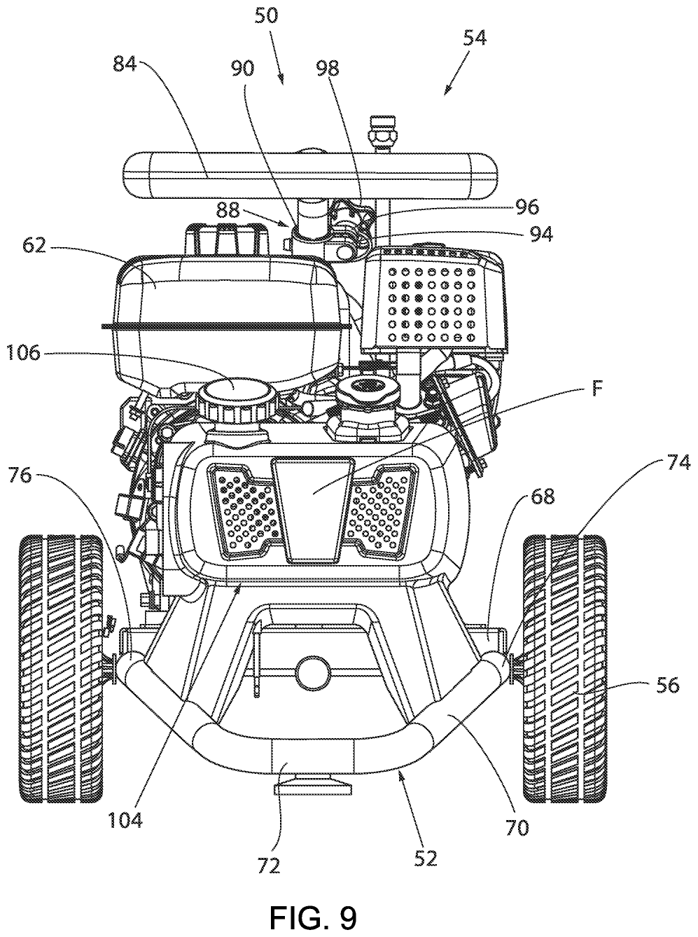

FIG. 9 is a front elevation view of the inventive pressure washer system of FIG. 8;

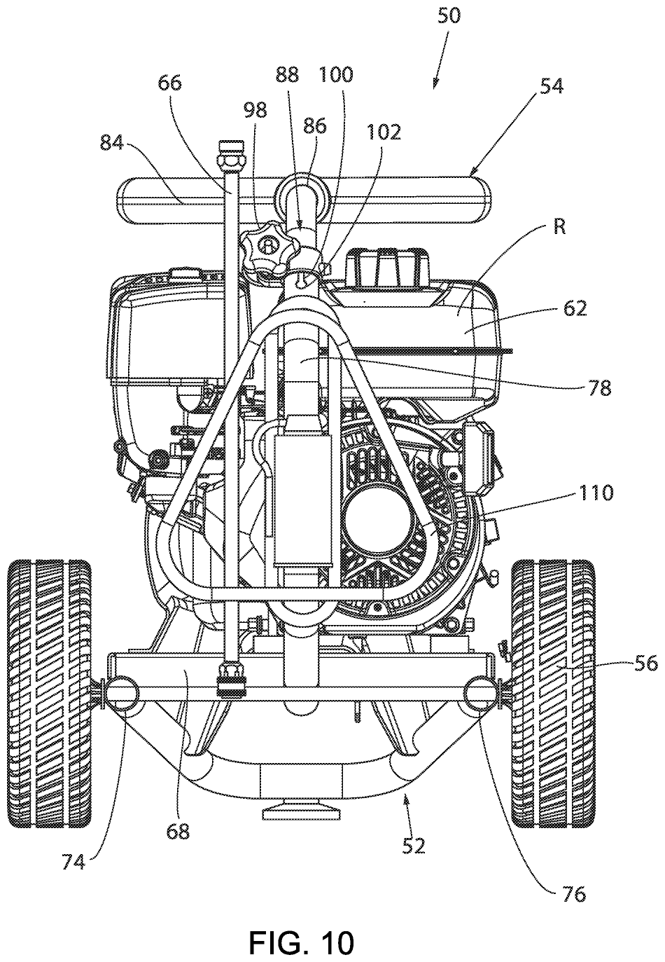

FIG. 10 is a rear elevation view of the inventive pressure washer system of FIGS. 8 and 9;

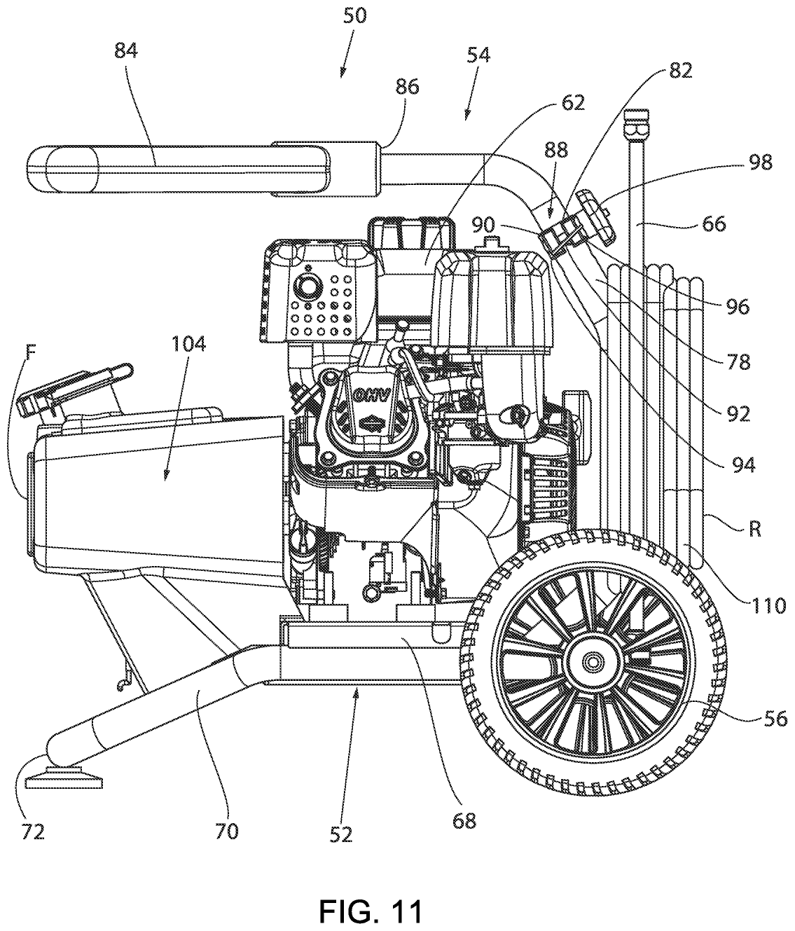

FIG. 11 is a first side elevation view of the inventive pressure washer system of FIGS. 8-10;

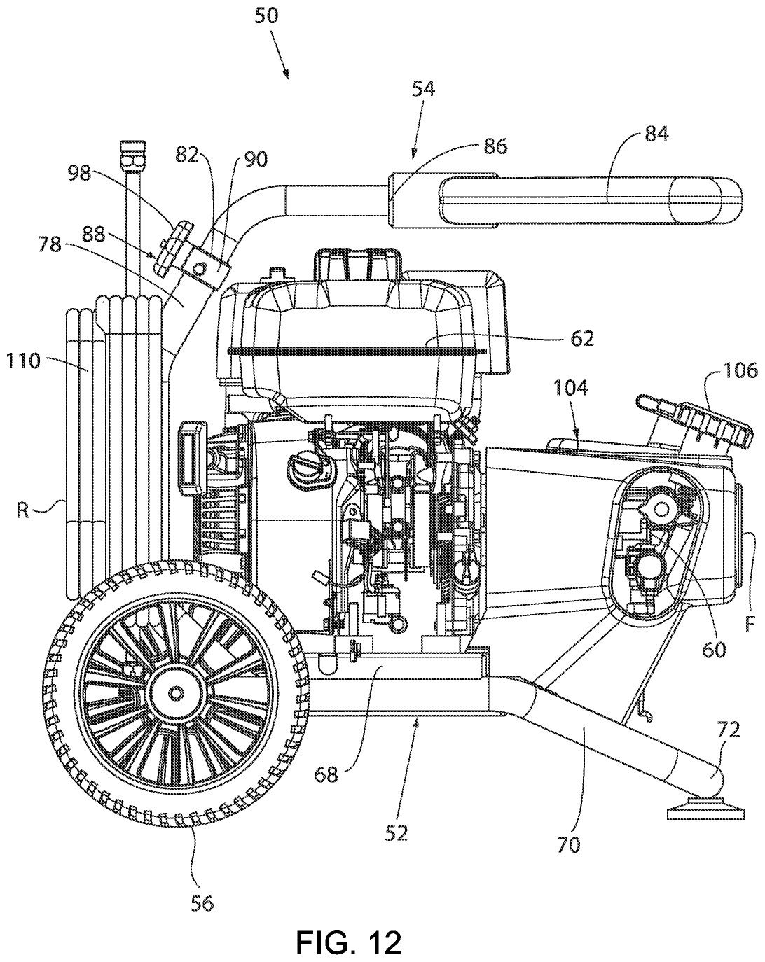

FIG. 12 is a second side elevation view of the inventive pressure washer system of FIGS. 8-11;

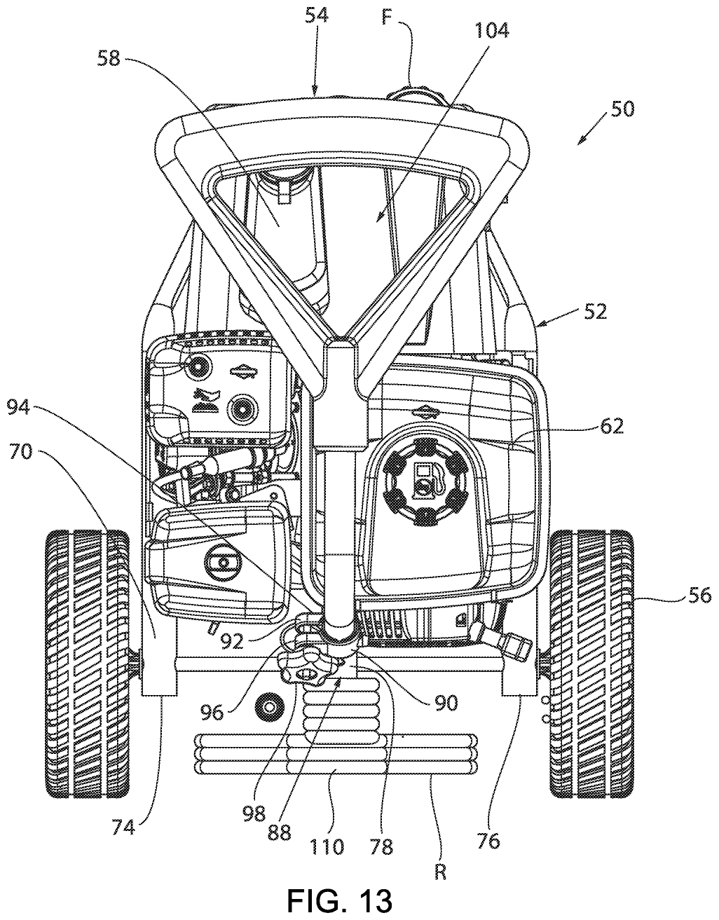

FIG. 13 is a top plan view of the inventive pressure washer system of FIGS. 8-12;

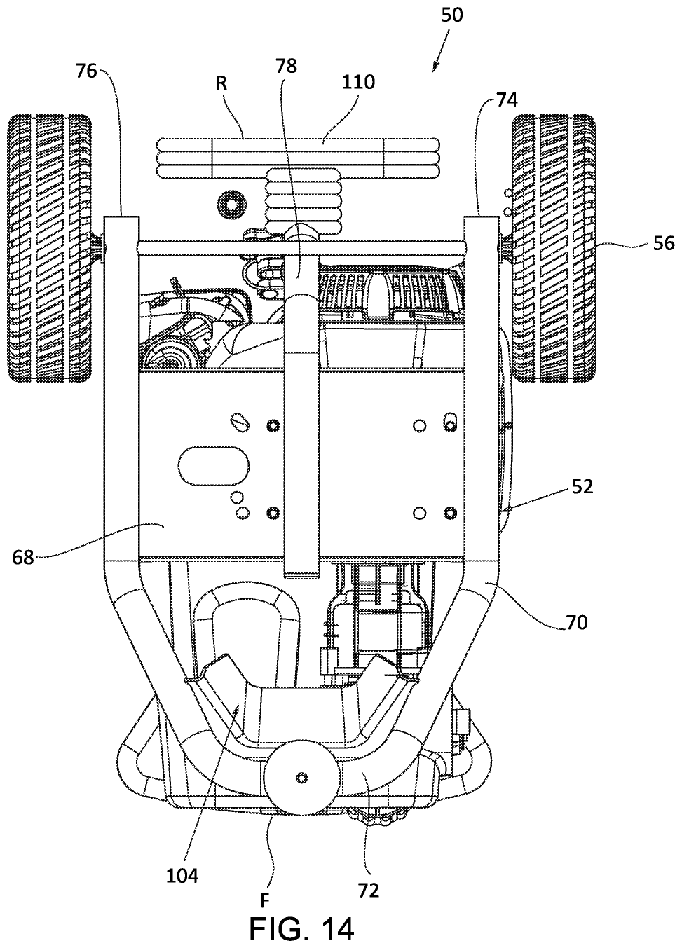

FIG. 14 is a bottom plan view of the inventive pressure washer system of FIGS. 8-13;

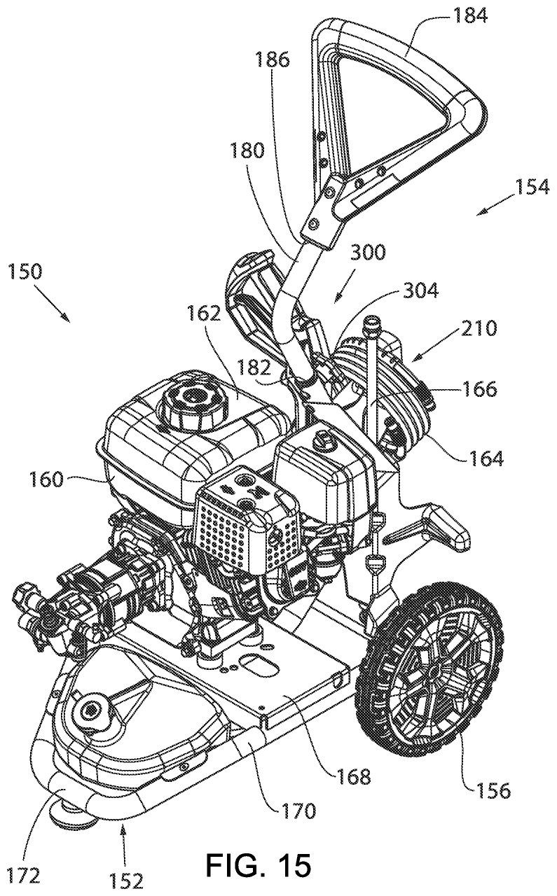

FIG. 15 is a top front isometric view of an inventive pressure washer system having a handle in a first, use-based position;

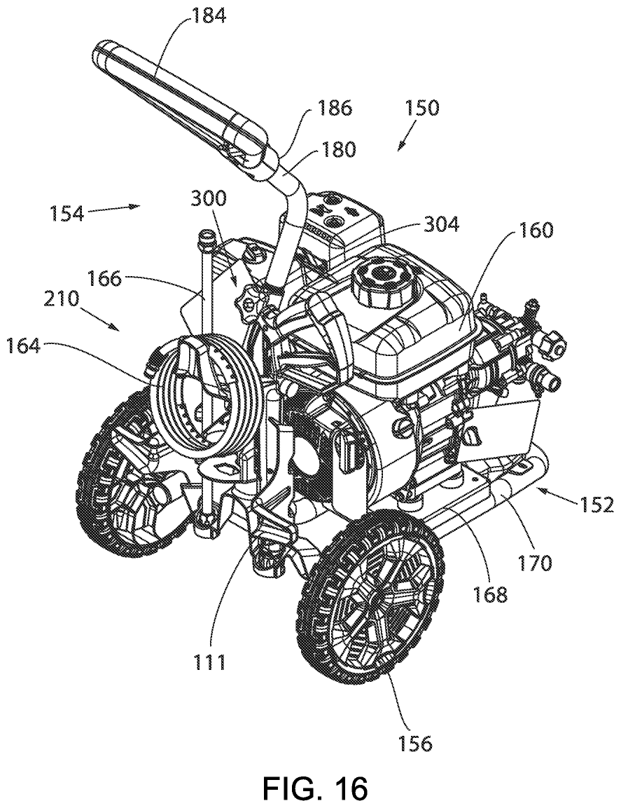

FIG. 16 is a top rear isometric view of an inventive pressure washer system having a handle in a first, use-based position;

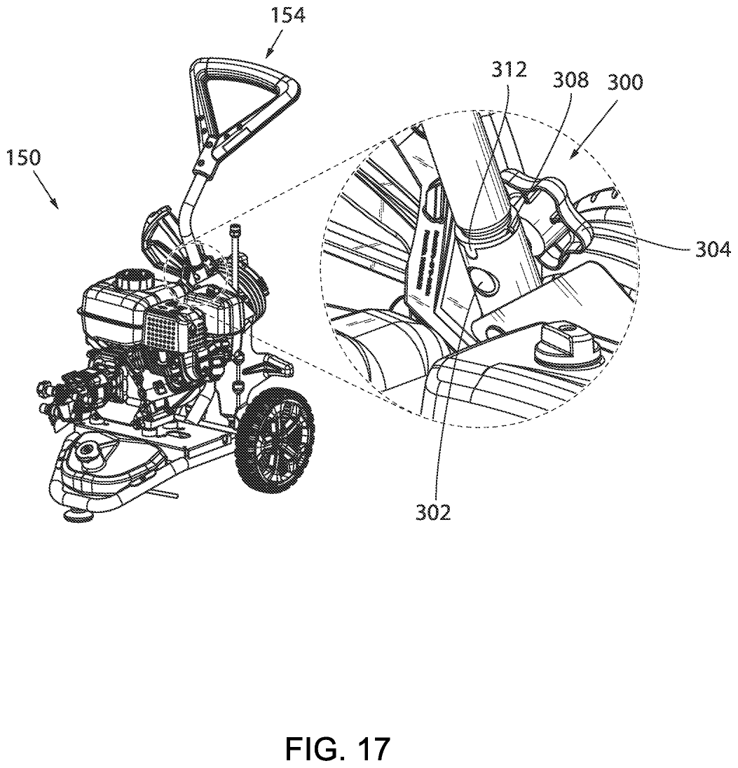

FIG. 17 is a detailed view of a portion of the handle of FIGS. 15 and 16 in a first position;

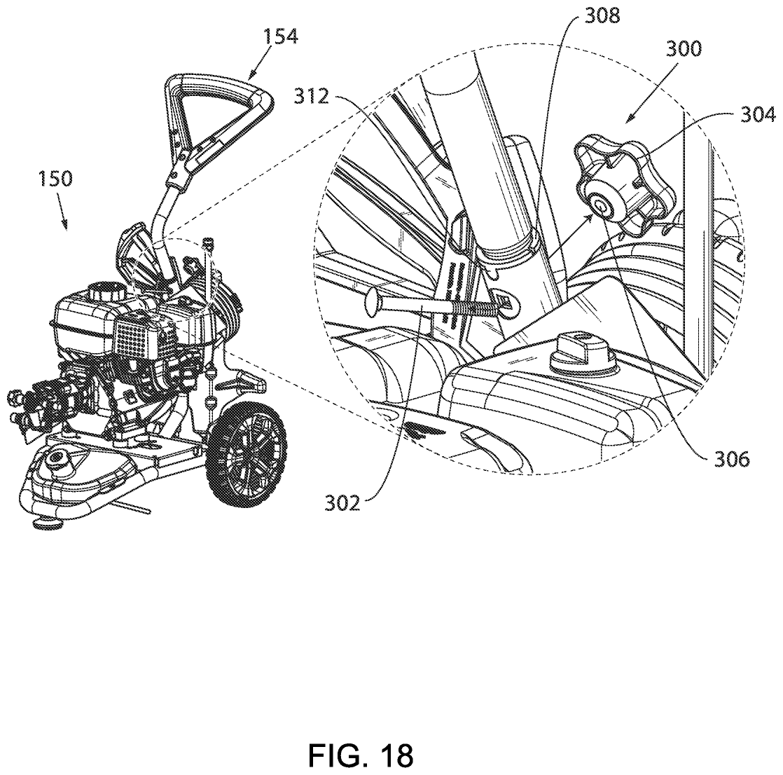

FIG. 18 is a detailed view of a portion of the handle of FIGS. 15 and 16 in a second position;

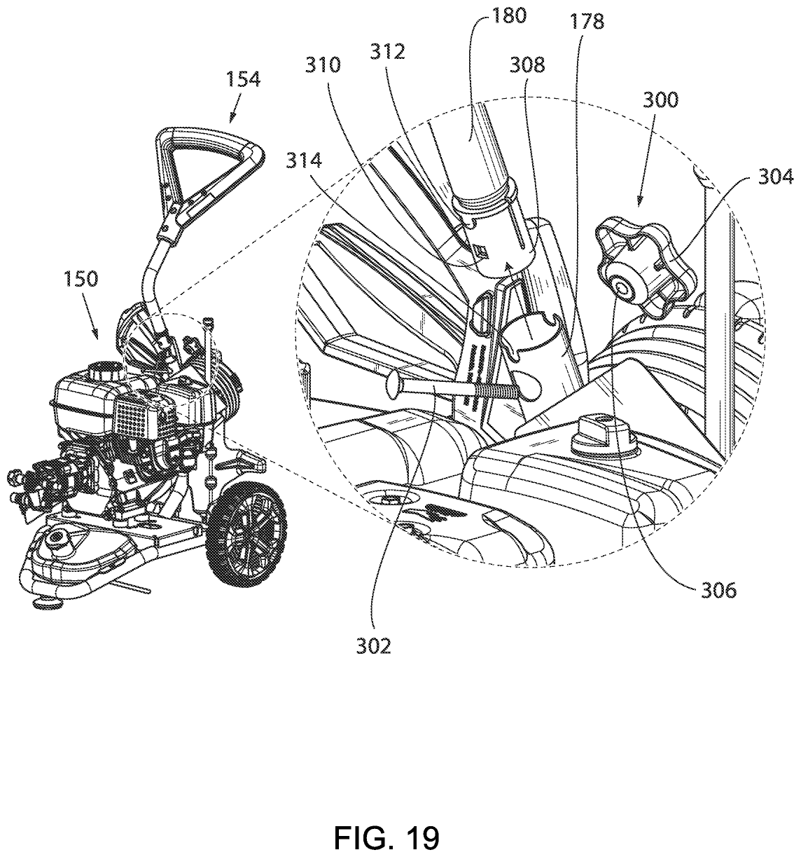

FIG. 19 is a detailed view of a portion of the handle of FIGS. 15 and 16 in a third position;

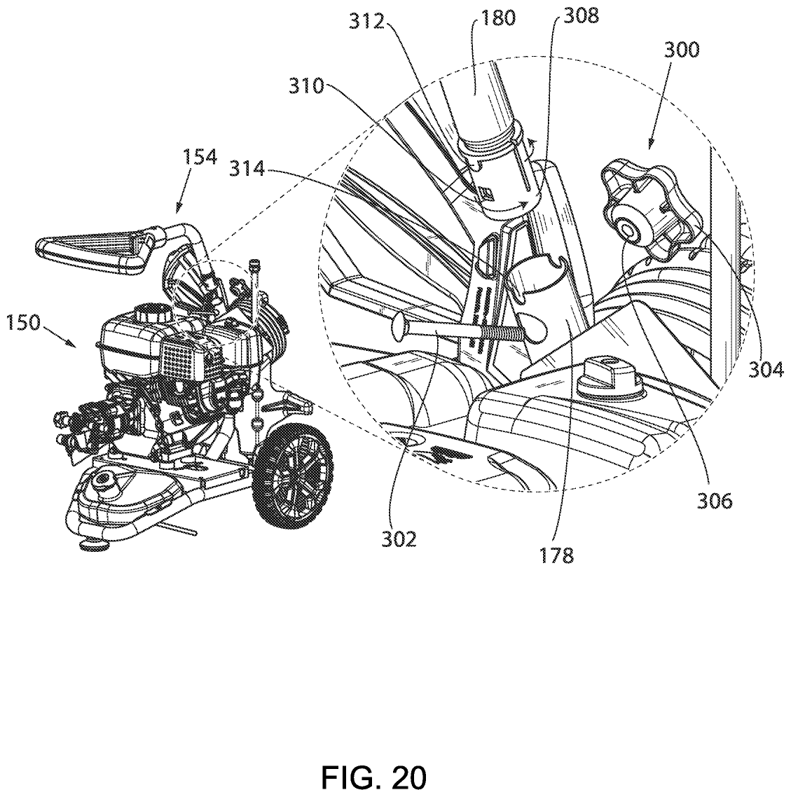

FIG. 20 is a detailed view of a portion of the handle of FIGS. 15 and 16 in a fourth position;

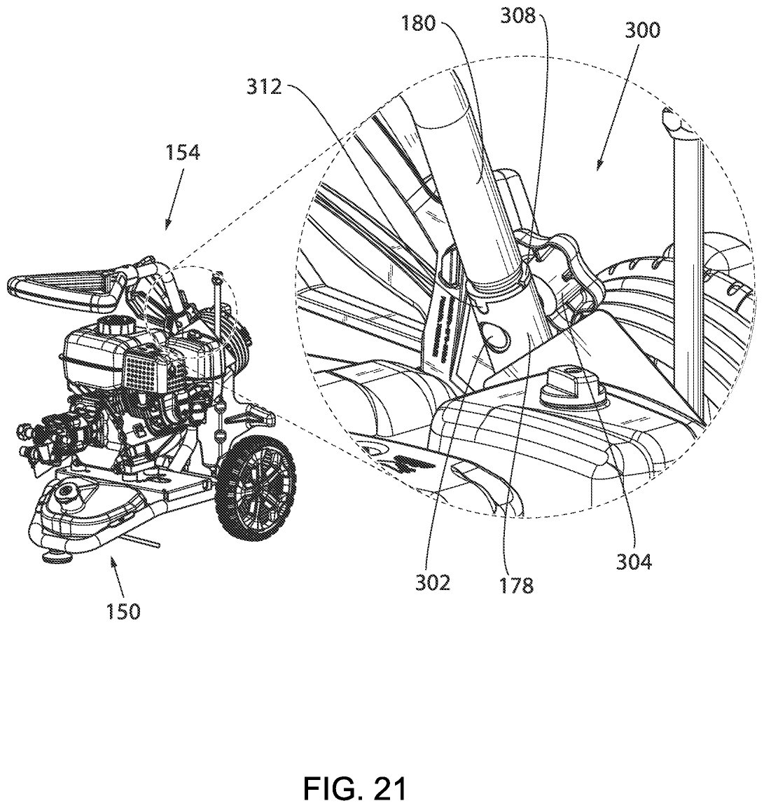

FIG. 21 is a detailed view of a portion of the handle of FIGS. 15 and 16 in a fifth position; and

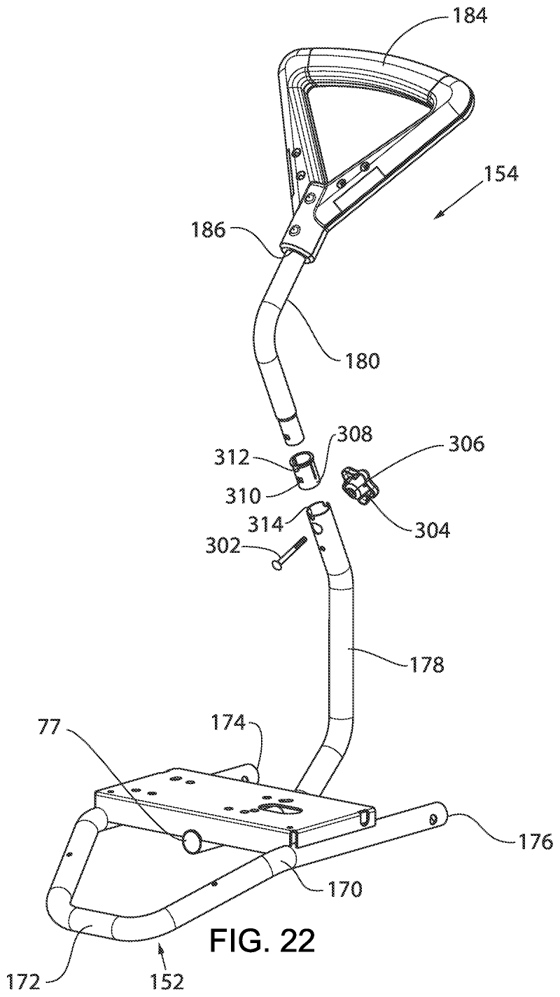

FIG. 22 is an exploded view of the handle and frame of the pressure washer system of FIGS. 15 and 16.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

The present invention is directed to a new pressure washer having a new frame configuration having a new look and style, as well a more ergonomic access to pump hookups and a larger unloader control (as described in U.S. Provisional Patent Application No. 63/434,615 filed on Dec. 22, 2022, the entirety of which is incorporated herein by reference). The new frame configuration also has a rotating handle that can be rotated to a lowered or collapsed configuration in which the pressure washer is ready for storage. The new frame configuration further includes a storage caddy configured to hold or store various accessories including guns, wands, hoses, and the like. Additionally, a shroud may be provided to cover at least part of the pressure washer and associated components, and to create an aesthetically pleasing appearance.

### 2. Detailed Description of Preferred Embodiments

The present invention is directed to a pressure washer system 50 having an updated frame 52 specifically configured to optimize performance of the pressure washer 50. The pressure washer 50 also includes a movable handle 54 that can be moved or rotated into a stowed, collapsed, or downward position in order to reduce the dimensions of the pressure washer 50 for storage or other purposes. While the illustrated embodiment is for use with a pressure washer 50, it should be noted that the underlying concepts associated with the described frame 52, handle 54, and any other component described herein could also be used with other types of equipment, particularly those that are wheeled from one location to another, including but not limited to lawnmowers, snowblowers, snow throwers, and the like.

As described above, the pressure washer 50 includes the frame 52 that is configured to support the various components associated therewith, and the handle 54 that is used to propel the frame 52 and associated components of the pressure washer 50 from one location to another. The pressure washer 50 also includes standard components, including two or more wheels 56 secured to the frame 52 that enable movement of the pressure washer 50 from one location to another, although the frame 52 could similarly be mounted to other trailers, trucks, or other vehicles. Additionally, the pressure washer 50 includes a storage container 58 configured to receive liquid, such as water, cleaning solution, soap, and the like, and a pump 60 contained within or adjacent to the container 58, where the pump 60 is configured to pump water from the container 58. A liquid source may be attached to the storage container 58 to provide continuous supply of the liquid, otherwise the storage container 58 may be of sufficient size that it can be operated for a period of time before additional liquid is provided. Although the pressure washer 50 ultimately sprays liquid at a high pressure, the liquid source may be of low pressure, such as a water spigot associated with a house or other building. Any number of different pumps may be used based on the requirements of the pressure washer 50 and the desires of the user. The pump 60 may be powered by an engine or motor 62. Any engine or motor known in the prior art, including gasoline powered, electric powered, or the like could be used. The engine or motor 62 may be mounted to a portion of the frame 52 and/or the container 58.

Further still, the pressure washer 50 includes a hose 64 extending from the container 58 and the pump 60. The liquid is pumped out of the storage container 58 to the hose 64, after which the liquid can either be dispensed directly out of the hose 64 through an opening, or through any number of accessories or dispensers that can be attached to the hose 64. The hose 64 is a high-pressure hose configured to maintain sufficient pressure and flow of the liquid as desired by a user. Potential accessories can include various tips and/or wands 66 configured to achieve different flow widths, patterns, angles, characteristics, and the like.

Initially, the frame 52 will be described. As shown, the frame 52 includes a baseplate 68 that extends substantially horizontally relative to the ground. The illustrated baseplate 68 is substantially rectangular in shape. The frame 52 further includes one or more frame tubes that extend around the baseplate 68. For instance, the illustrated embodiment has a frame tube 70 that is substantially V-shaped, with the point 72 of the “V” located at the front of the frame 52, with the tops 74, 76 of the “V” extending beyond the rear of the baseplate 68 on either side of the baseplate 68. Axles of each wheel 56 may extend through the tops 74, 76 of the “V” beyond the rear of the baseplate 68. Additionally, a new cut 77 is formed in the baseplate 68 that enables a lower portion 78 of the handle 54 (which will be further explained below) to be welded to the baseplate 68.

Next, the handle 54 will be described. The handle 54 includes multiple components that enable the handle 54 to be quickly and easily moved between a use-based position in which the pressure washer 50 is pushed from the rear in a forward direction from one location to the next as shown in FIGS. 1-7, and a stowed position in which the dimensions of the pressure washer 50, and more specifically the length and the height of the pressure washer 50, is reduced to a smaller size in order to enable storage as shown in FIGS. 8-14. While movement of the handle 54 is described herein as being rotational in nature about a pivot point, the handle 54 could similarly move in different directions, along different axis, etc. within the scope of the present invention.

The first portion of the handle 54 is a lower handle section 78 that may actually be formed with, welded to, or otherwise attached to the frame 52. As shown, the lower handle section 78 is welded to the baseplate 68 of the frame 52, and extends rearwardly therefrom, and bends around the other components of the pressure washer 50, such as the storage compartment 58 and the engine 62. The second portion of the handle is an upper handle section 80 that is configured to be movable relative to the lower handle section 78 in order to move the handle 54 between the use-based position and the stowed position. As shown, the upper handle section 80 is curved, with a first end 82 being inserted into the lower handle section 78. The upper handle section 80 may have a gripping section 84 formed in the second end 86, otherwise as shown a separate gripping section 84 may be attached to the second end 86. The illustrated gripping section 84 is the actual handle that a user grips, as shown a substantially triangularly-shaped handle.

Additionally, the handle 54 includes a component 88 that is capable of releasably holding the upper handle section 80 in place relative to the lower handle section 78. In the illustrated embodiment, the component 88 is akin to a bike seat post, which includes a collar 90 that wraps around and surrounds the location where the upper handle section 80 is inserted into the lower handle section 78, a screw 92 extending from a first side 94 of the collar 90 to a second side 96 of the collar 90, and a knob 98 or handle that is attached to the screw 92 to enable easy rotation of the screw 92.

Initially, the collar 90 and screw 92 will be in a tightened orientation, which prevents the upper handle section 80 from moving relative to the lower handle section 78. When a user wants to move the handle 54 to a different orientation, the knob 98 is rotated in a first direction to loosen the screw 92, and in turn separate the respective sides 94, 96 of the collar 90 in order to loosen the collar 90. Once this occurs, the upper handle section 80 is movable relative to the lower handle section 78. Once the upper handle section 80 is located in a desired orientation, the knob 98 is rotated in a second direction to tighten the screw 92, and in turn pull the respective sides 94, 96 of the collar 90 together in order to tighten the collar 90 around the upper handle section 80 and the lower handle section 78. This can repeatedly be done quickly and easily, while allowing the handle 54 to maintain a ridged connection to the frame 52 to ensure prompt mobility of the pressure washer system 50. Additionally, a notch 100 may be formed in the lower handle section 78, and a similarly a spring button 102 may be added that would need to be released to move the handle 54 between the respective positions. Of course, the upper handle section 80 and the lower handle section 78 could be releasably secured to one another in any number of different ways, including a clamp, a quick clamp, or any other type of fastener.

As seen in the figures, in the use-based position, the upper handle section 80 of the handle 54 extends rearwardly from the pressure washer 50 at an angle, for instance between 25-75 degrees relative to the vertical, although it could extend at an angle desired in order to enable easy pushing of the pressure washer 50 from one location to another. When it is moved to the stowed position, the upper handle section 80 is rotated approximately 180 degrees relative to a longitudinal axis LA extending through the pressure washer 50, such that it then extends towards the front F of the power washer 50. In the illustrated embodiment, the upper handle section 80 extends substantially parallel with the ground when moved to the stowed position. While the stowed position is useful in that the dimensions of the pressure washer 50 are reduced, the pressure washer 50 can still be moved by orienting a user at the front F of the pressure washer 50 and pulling the gripping section 84 towards the front F of the pressure washer 50.

Another embodiment of the pressure washer is shown in FIGS. 15-22 in which like components are shown using the same reference numbers as those in FIGS. 1-14 incremented by 100. This embodiment includes a different adjustable component 300 configured to enable adjustment of the upper handle section 180 relative to the lower handle section 178. FIGS. 17-21 show the adjustable component 300 being manipulated to change the orientation of the upper handle section 180 relative to the lower handle section 178. The adjustable component 300 includes a bolt, screw, or other threaded device 302 and a knob 304 having an opening 306 formed therein such that the knob 304 is rotatably mountable to the threaded device 302. As shown in FIG. 17, the knob 304 is initially secured to the threaded device 302 so as to keep the handle 154 in its located position. When a user desires to adjust the handle 154, the knob 304 can be unscrewed as shown in FIG. 18. Thereafter, the upper handle section 180 can be removed from the lower handle section 178 as best seen in FIG. 19. Still looking to FIG. 19, the handle 154 may further include a sleeve 308 having openings 310 formed therein. The sleeve 308 additionally may have one or more fingers 312 extending therefrom that interface with grooves 314 formed in the lower handle section 178. As shown, the sleeve 308 is associated with the upper handle section 180. Thus, when the upper handle section 180 is removed from the lower handle section 178, the sleeve 308 is similarly removed from the lower handle section 178. As shown, the upper handle section 180 can then be rotated (see FIG. 20) to move the upper handle section 180 between the raised and lowered positions. Once the upper handle section 180 reaches a desired location, the upper handle section 180 and sleeve 308 can be reinserted into the lower handle section 178, with the fingers 312 interfacing with the groove 314 to properly locate the upper handle section 180 relative to the lower handle section 178. Once this occurs, the threaded device 302 can be located about the opening 306 of the knob 304, and the knob 304 can be tightened relative to the threaded device 302 in order to secure the lower handle section 178 and the upper handle section 180 together.

The pressure washer 50 may also include a shroud 104 configured to surround at least a portion of the pressure washer 50 and associated components. As shown, the shroud 104 is a front shroud that surrounds the pump 60 and a knob or handle 106 (described below) configured to control the pump 60. The shroud 104 may include one or more openings that enable access to various components. For instance, as shown, the shroud 104 includes an opening 108 configured to receive the knob or handle 106, such that it extends through the shroud 104 to enable easy access. The shroud 104 provides an aesthetically pleasing appearance at the front F of the pressure washer 50. As shown, the shroud 50 is mounted to the baseplate 68, although it could similarly be mounted to the frame 52 and/or other components of the pressure washer 50 using clips. Of course, the shroud 104 could similarly be mounted using a snap fit, screws, bolts, fasteners, and the like.

Operation of the pump 60 may be controlled by a standard handle (not shown) that is twisted in one direction multiple times to initiate flow and in an opposite direction multiple times to terminate flow. Alternatively, an improved adjustable knob or handle 106 associated with a valve (not shown) located where the liquid exits the storage container 58 and enters the dispenser hose 64 may be used. The knob 106 is configured to be easily manipulated in order to regulate flow from the container 58 independent of the flow characteristics and pressure of liquid exiting the pump 60. Stated differently, the knob 106 and valve can be manipulated if desired to result in liquid leaving the pressure washer 50 at a pressure less than the pressure of the liquid when it leaves the pump 60. Advantageously, in a preferred embodiment the knob 106 has a maximum rotation of 360 degrees or less. This means that a user can toggle between an “off” position in which little or no liquid is flowing from the container 58 to a maximum position in which liquid is flowing from the container 58 at a maximum rate and pressure with one single 360 degree rotation of the knob 106. In other embodiments, the total rotation may be less than 360 degrees. The valve and/or the pump 60 may also have a relief mechanism.

A user may twist the knob 106 the full 360 degrees, or an intermediate portion of the full rotation in the event that partial flow is desired between the maximum and minimum pressure. For instance, the knob 106 may be gradually rotated to any position within 360 degrees in certain embodiments. Typically, the pressure will increase linearly while the knob is rotated. In other embodiments, the knob 106 may be biased towards a number of preset locations. For instance, the knob 106 may be biased between the opened position, to another position approximately 180 degrees relative to the Y-axis which would constitute a 50% pressure, and to the closed position. In another embodiment, the knob 106 may be biased between the opened position, to a position approximately 90 degrees relative to the Y-axis which would consisted a 75% pressure, to another position approximately 180 degrees relative to the Y-axis which would constitute a 50% pressure, to yet another position approximately 270 degrees relative to the Y-axis which would constitute 25% pressure, and to the closed position. Of course, the knob 106 may be biased to additional intermediate positions as may be desired by a given user.

Further still, the pressure washer 50 may include a storage caddy 110. As shown, the storage caddy 110 is mountable relative to a rear R of the pressure washer 50 adjacent to the handle 54. The storage caddy 110 is shown mounted to the frame 52 and/or the handle 54 using clips, although it could similarly be mounted using a snap fit, screws, bolts, fasteners, and the like. The storage caddy 110 includes an interior storage compartment 112 that can hold various wands, guns, and other accessories, as well as cleaning solution, towels, rags, and any other objects needed in connection with use of the pressure washer 50. Additionally, the storage caddy 110 may include one or more protrusions 114 extending outwardly therefrom in order to wrap up a hose associated with the pressure washer 50. For instance, the storage caddy 110 may include three protrusions 111 (see FIG. 16), with one extending substantially vertically from a top of the storage caddy 110, and second and third protrusions extending substantially horizontally from either side of the storage caddy 110, such that the hose can be repeatedly wrapped around the storage caddy 110 for ease of transportation and to prevent dragging or tangling of the hose.

According to another aspect of the present invention, a method of using the pressure washer system 50 is provided that includes the steps of filling the container 58 with a volume of liquid, moving the pressure washer 50 to a desired location by pushing the handle 54, controlling flow of the liquid from the container 58, pumping at least some of the volume of liquid from the container 58, moving the pressure washer system 50 to a storage area once use is complete, and moving the handle 54 to a stowed position. The method may further include the steps of propelling the pressure washer system 50 when the handle 54 is in a use-based position where it extends rearwardly from the pressure washer system 50, and then rotating the handle 54 to a stowed position in which the dimensions of the pressure washer system 50 are smaller than the dimensions of the pressure washer system 50 when the handle 54 is in the use-based position. The method may further include the steps of propelling the pressure washer system 50 in a frontward direction when the handle 54 is in the use-based position by pushing the handle 54 toward the front F of the pressure washer system 50, and/or propelling the pressure washer system 50 in the frontward direction when the handle 54 is in the stowed position by pulling the handle 54 toward the front F of the pressure washer system 50.

The method also may include the steps of releasing the upper rotating handle section 80 from releasable engagement with the lower handle section 78 and rotating the upper rotating handle section 80 relative to the lower handle section 78. For instance, the releasing step may include the steps of disengaging a quick clamp that is configured to releasably hold the upper rotating handle section 80 relative to the lower handle section 78, after which the rotating upper handle section 80 can be rotated, after which the quick clamp can be reengaged. Alternatively, the screw 92 can be rotated in a first direction to loosen the collar 90, after which the upper handle section 80 can be rotated relative to the lower handle section 78, after which the screw 92 can be rotated in a second direction to tighten the collar 90. The method may also include the step of rotating the upper rotating handle section 80 approximately 180 degrees relative to the longitudinal axis LA extending through the pressure washer 50 from the use-based position to the stowed position. Further still, the method may include the step of mounting the shroud 104 to a front section of the pressure washer 50.

The method may also include the step of rotating the adjustable pressure knob 106 between 1 degree and 360 degrees to enable flow of the liquid from the container 58. The knob 106 can be moved from a first opened position to a second closed position, with a plurality of intermediate positions therebetween.

All the disclosed embodiments are useful in conjunction with storage, transportation, and pumping of liquid from a container at a desired and easily changeable pressure. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the various components are described herein as being physically separate modules, it will be manifest that any of the components may be manufactured together or later assembled with one another. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A pressure washer system comprising:
a frame;
a container carried by the frame configured to receive a volume of liquid;
a pump configured to pump the liquid from the container;
a dispenser attached to the container for distributing the liquid out of the container; and
a handle connected to the frame, the handle being movable relative to the frame between:
a use-based position in which the handle is pushed to propel the pressure washer, wherein the handle has a first dimension in the use-based position; and
a stowed position in which the handle has a second dimension smaller than the first dimension when the handle is in the use-based position.

2. The pressure washer system of claim 1, wherein the handle further comprises:
a lower handle section fixedly extending from the frame;
an upper rotating handle section rotatable relative to the lower handle section; and
a gripping handle section fixedly extending from the upper rotating handle section.

3. The pressure washer system of claim 2, wherein the upper rotating handle section is releasably secured to the lower handle section by a quick clamp.

4. The pressure washer system of claim 2, wherein the upper rotating handle section is releasably secured to the lower handle section using a mounting shaft collar and a screw.

5. The pressure washer system of claim 2, further comprising:
a sleeve configured to receive an end of the upper rotating handle section;
a threaded device configured to be removably inserted into a plurality of openings formed in the sleeve, the upper rotating handle section and the lower handle section; and
a knob having an opening configured to receive a portion of the threaded device.

6. The pressure washer system of claim 5, wherein the sleeve further comprises at least one tab; and
wherein the lower handle section further comprises at least one groove configured to receive the at least one tab.

7. The pressure washer system of claim 2, wherein the upper rotating handle section rotates approximately 180 degrees about a longitudinal axis of the pressure washer when it is rotated relative to the lower handle section in order to move the handle from use-based position to the stowed position.

8. The pressure washer system of claim 2, wherein the upper rotating handle section is substantially parallel to the ground when in the stowed position.

9. The pressure washer system of claim 1, further comprising a storage caddy configured to receive one or more of a hose, a wand, and an accessory.

10. The pressure washer system of claim 1, further comprising a shroud configured to be removably mounted to a portion of the pressure washer to surround a portion of the pressure washer.

11. The pressure washer system of claim 10, wherein the pressure washer further comprises an adjustable pressure knob between the container and the dispenser, the adjustable pressure knob configured to only be rotated 360 degrees or less; and
wherein the shroud further comprises at least one opening configured to receive the adjustable pressure knob when the shroud is mounted to the pressure washer.

12. A method of using a pressure washer system comprising the steps of:
filling a container with a volume of liquid;
moving the pressure washer system to a desired location by pushing a handle;
controlling flow of the liquid from the container;
pumping at least some of the volume of liquid from the container;
moving the pressure washer system to a storage area once use is complete; and
moving the handle to a stowed position.

13. The method of claim 12, further comprising the steps of:
propelling the pressure washer system when the handle is in a use-based position where it extends rearwardly from the pressure washer system; and
rotating the handle to the stowed position in which the dimensions of the pressure washer system are smaller than the dimensions of the pressure washer system when the handle is in the use-based position.

14. The method of claim 13, further comprising the steps of:
propelling the pressure washer system in a frontward direction when the handle is in the use-based position by pushing the handle toward the front of the pressure washer system; and
propelling the pressure washer system in the frontward direction when the handle is in the stowed position by pulling the handle toward the front of the pressure washer system.

15. The method of claim 12, further comprising the steps of:
releasing an upper rotating handle section from releasable engagement with a lower handle section; and
rotating the upper rotating handle section relative to the lower handle section.

16. The method of claim 15, further comprising the steps of:
disengaging a knob from a threaded device configured to releasably hold the upper rotating handle section in place relative to the lower handle section;
removing the threaded device from a plurality of openings formed in the upper rotating handle section and the lower handle section;
rotating the upper rotating handle section relative to the lower handle section; and
reengaging the knob and the threaded device to releasably hold the upper rotating handle section in place relative to the lower handle section.

17. The method of claim 15, further comprising the steps of:
rotating a screw in a first direction to loosen a collar configured to releasably hold the upper rotating handle section in place relative to the lower handle section;
rotating the upper rotating handle section relative to the lower handle section; and
rotating the screw in a second direction to tighten the collar to releasably hold the upper rotating handle section in place relative to the lower handle section.

18. The method of claim 15, further comprising the step of rotating the upper rotating handle section approximately 180 degrees relative to a longitudinal axis extending through the pressure washer from the use-based position to the stowed position.

19. The method of claim 12, further comprising the steps of:
mounting a shroud to a front section of the pressure washer system to surround at least a portion of the front section; and
moving the adjustable pressure knob between:
a first opened position in which the adjustable pressure knob is at a substantially 1 degree angle relative to the Y-axis in which the liquid is pumped from the container;
a second closed position in which the adjustable pressure knob is at a substantially 359 degree angle relative to the Y-axis in which the liquid remains within the container, and
a plurality of intermediate positions between the first opened position and the second closed position.

20. A system configured to transport and distribute liquid comprising:
a frame;
a container carried by the frame configured to receive a volume of liquid; and
a handle connected to the frame, the handle being movable relative to the frame between:
a use-based position in which the handle is upwardly oriented and pushed towards a front end of the frame to propel the pressure washer; and
a stowed position in which the handle is oriented substantially horizontally.
